(19) United States
(12) Patent Application Publication
(10) Pub. No.: US 2026/0346452 A1
(43) Pub. Date: Nov. 5, 2026

(54) ROBOTIC SYSTEM FOR HORIZONTAL PIPE HANDLING ON A DRILL RIG

(71) Applicant: NATIONAL OILWELL VARCO, L.P., Houston, TX (US)

(72) Inventors: Graham Alexander Carnegie, Cypress, TX (US); Jay John Thiessen, Edmonton (CA); Jonathan Douglass Callaghan, Edmonton (CA); Elie Chehade, Dubai (AE); Karl Bernhard Henriksen, Kristiansand (NO); Muhammad Fahad, Katy, TX (US)

(21) Appl. No.: 19/488,032

(22) PCT Filed: Jun. 21, 2024
(86) PCT No.: PCT/US2024/035103

§ 371 Date: Nov. 25, 2025

Related U.S. Application Data
(60) Provisional application No. 63/523,447, filed on Jun. 27, 2023.

(51) Int. Cl. B25J 9/16; B25J 9/00; E21B 19/15

(52) U.S. Cl. CPC B25J 9/1682; B25J 9/0084; E21B 19/155

(57) ABSTRACT

A robotic pipe handling system can include at least two robotic manipulators, one positioned on either side of an individual piece of drill pipe, to pick the individual piece up and move it horizontally from one point to another. The system can include at least one elongate drill pipe storage area including a plurality of drill pipe receptacles. The system can also include a controller for coordinating movements of the first and second robotic manipulators with each other to horizontally lift the first piece of drill pipe and move the first piece of drill pipe toward a pipe-receiving area.

### CLAIM OF PRIORITY

This application claims priority to U.S. Provisional Application Ser. No. 63/523,447, filed on Jun. 27, 2023, which is incorporated by reference herein in its entirety, and the benefit of priority of which is claimed herein.

### FIELD OF INVENTION

The present disclosure relates to tubular handling on or around drill rigs such as those used for drilling oil wells. More particularly, the present disclosure relates to a tubular handling system for delivering drill pipes or pipes stands to a drill rig.

### BACKGROUND

Drilling into the earth's crust, such as for pumping crude oil, can involve assembling a rig to bore relatively long lengths into the ground, e.g., greater than a mile deep. Such a rig can include a drill string including several pieces of drill pipe and the bottom hole assembly (BHA), which is the tubular portion closest to and including the drill bit. Land-based and offshore drilling operations, such as oil drilling operations, typically include the use of a drill string driven by a top drive. The drill string can include a drill bit and a plurality of drill pipe joints or lengths. As the wellbore drilled by the drill string deepens, more lengths of drill pipe can be added to the drill string. The process of connecting single joints of drill pipe into multi joint stands is often referred to as standbuilding. Each length of drill pipe can have a length of approximately 30 feet, such that a double stand can have a length of approximately 60 feet, and a triple stand can have a length of approximately 90 feet. These double or triple stands can be connected on or off the drill rig and used to continually lengthen the drill string during drilling operations.

### SUMMARY

In an example, the robotic system can be arranged to feed pieces of drill pipe for assembly with one another at or near a catwalk of a drill rig. For example, the system can include at least one elongate drill pipe storage area including a plurality of drill pipe receptacles. pipe storage area, and the first robotic manipulator can grab or hold a first piece of drill pipe at or near a first end. A second robotic manipulator can be disposed toward a second end of the at least one elongate drill pipe storage area, and the second robotic manipulator can grab or hold the first piece of drill pipe at or near a second end. The system can include a controller for coordinating movements of the first and second robotic manipulators with each other to horizontally lift the first piece of drill pipe from a corresponding first drill pipe receptacle and move the first piece of drill pipe toward a pipe-receiving area. Here, a load on the robotic system, including a weight of the first piece of drill pipe, can be approximately evenly distributed between the first and second robotic manipulators during a horizontal lift of the first piece of drill pipe from the corresponding first drill pipe receptacle.

In an example, the at least one elongate drill pipe storage area can include first and second mounts each include linear track arranged to respectively guide the first and second robotic manipulators in a transverse direction substantially orthogonal to the longitudinal direction. Here, the first and second mounts can be respectively located at the first and second ends of the at least one drill pipe storage area, the first and second mounts sized and shaped to respectively receive the first and second robotic manipulators.

In an example, the robotic system can retrieve an individual piece of drill pipe from a bin or container. Multiple containers can be aligned and affixed together the first and second robotic manipulators can travel along the linear track to traverse between containers. In an example, individual pieces of drill pipe can be oriented horizontally within the bin, e.g., stacked in multiple layers. Here, vertical spacers can be included in the bin to support an individual layer of drill pipe pieces, and the vertical spacers can be retractable upon removal of the layer from the bin. In an example, the robot can include a control system to use feedback from the robot to sense when it is in contact with an individual piece of pipe, e.g., by sensing a weight of the pipe being lifted or via feedback from an optical sensor.

Each of the non-limiting examples described herein can stand on its own, or can be combined in various permutations or combinations with one or more of the other examples.

This Summary is intended to provide an overview of the subject matter of the present patent application. It is not intended to provide an exclusive or exhaustive explanation of the invention. The detailed description is included to provide further information.

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

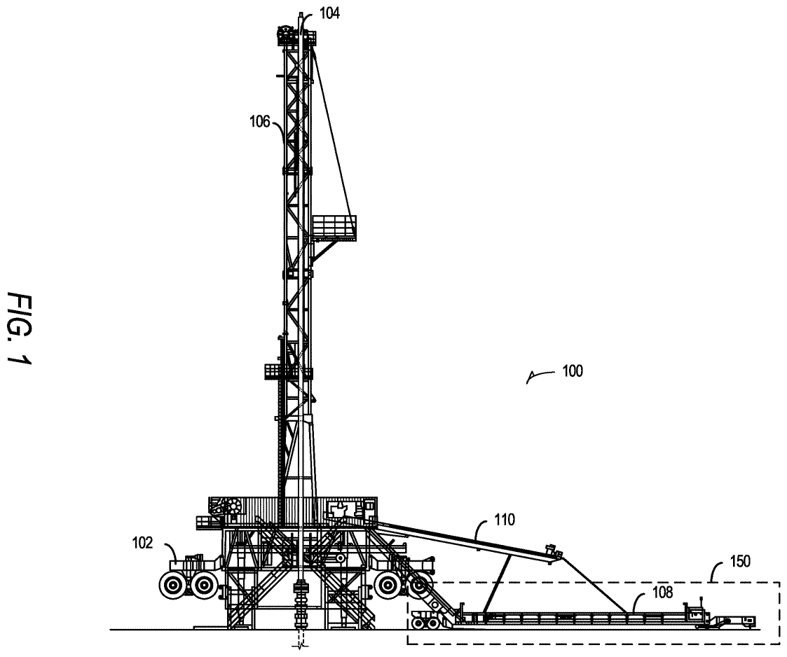

FIG. 1 depicts an example of a drill rig including a rig derrick.

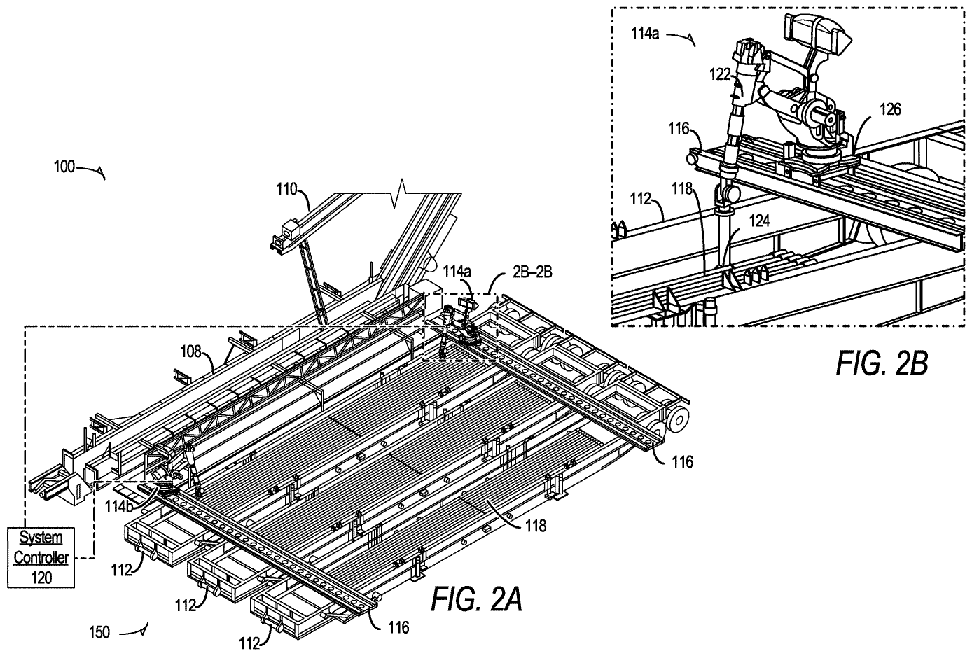

FIG. 2A is a perspective view of an example of a robotic handling system arranged adjacent to a catwalk as a part of a drill rig.

FIG. 2B is a detailed view of the example of a robotic handling system of FIG. 2A.

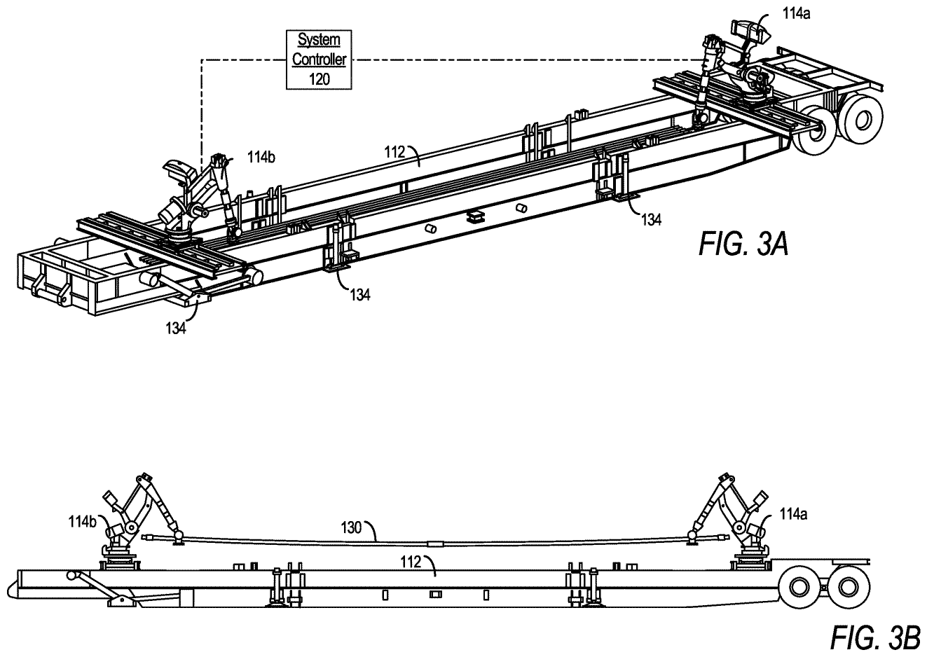

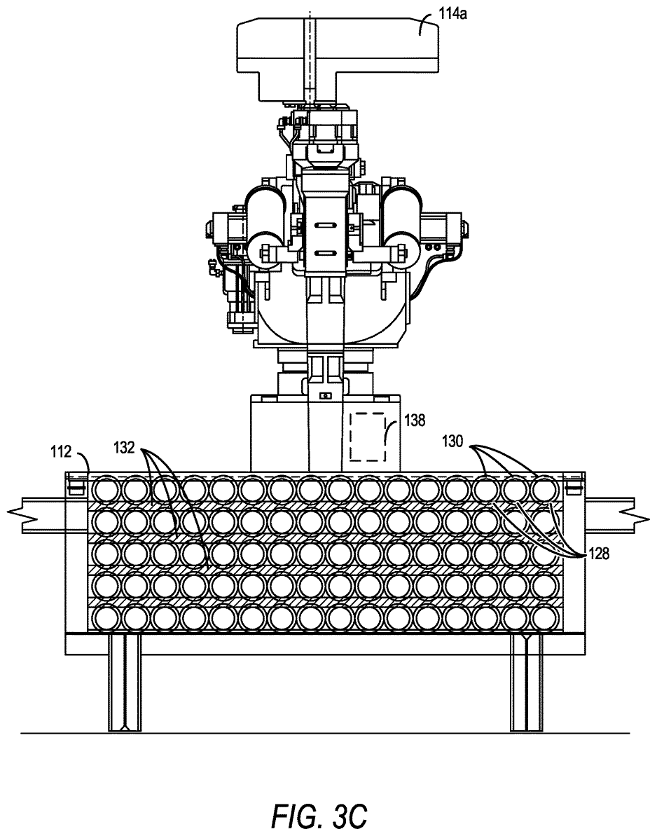

FIG. 3A is a perspective view of an example of an elongate drill pipe storage area included as a part of a robotic pipe handling system.

FIG. 3B is a side view of an example of an elongate drill pipe storage area included as a part of a robotic pipe handling system.

FIG. 3C is a cross section depicting an example of an elongate drill pipe storage area included as a part of a robotic pipe handling system.

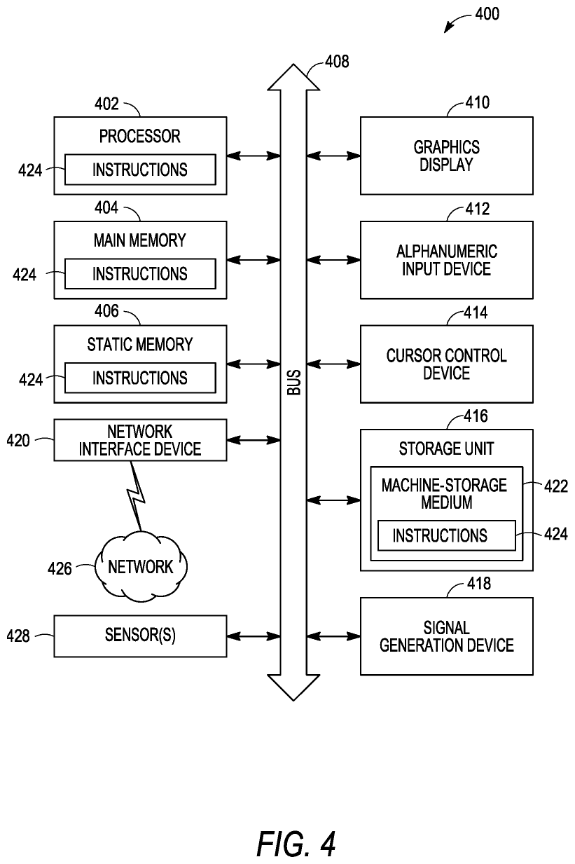

FIG. 4 is a block diagram illustrating components of a machine.

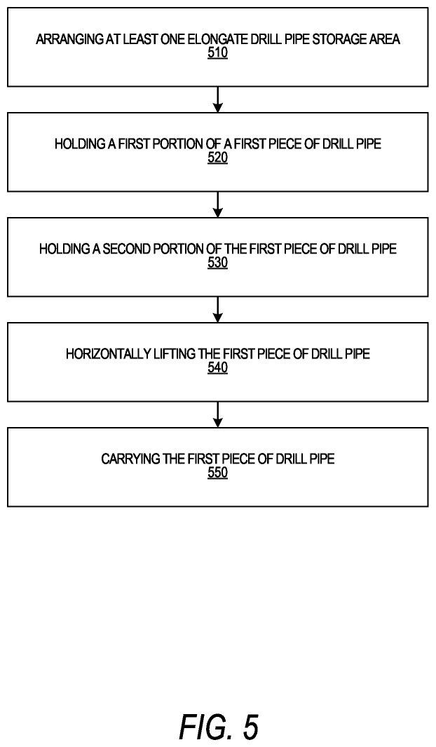

FIG. 5 is a flowchart that describes a method for operating a robotic system.

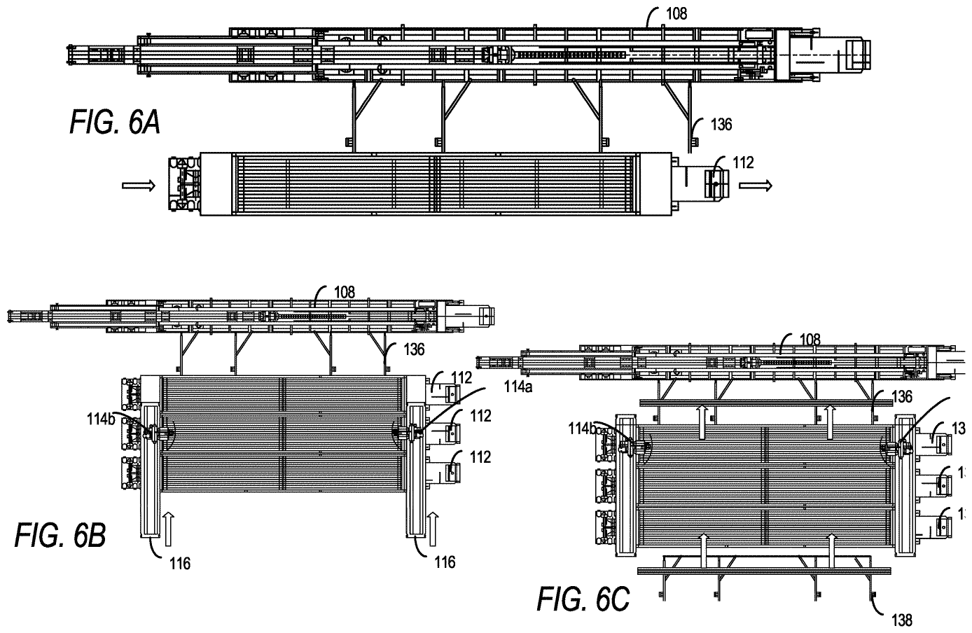

FIG. 6A is a top view depicting an assembly of an example of a robotic pipe handling system as a part of a drill rig.

FIG. 6B is a top view depicting an assembly of an example of a robotic pipe handling system as a part of a drill rig.

FIG. 6C is a top view depicting an operation of an example of a robotic pipe handling system as a part of a drill rig.

### DETAILED DESCRIPTION

This document describes a robotic system for handling pieces of drill pipe, such as for lengthening a drill string of a drill rig. A drill rig can include a derrick with one or more stands of threaded drill pipe suspended from the top of the derrick. Where multiple stands are loaded onto the drill rig, they can be set in a setback area e.g., using a “finger board” or “racking board” holding the top portions of the individual pieces of drill pipe to help prevent them from tipping over. The top portions of the individual pieces of drill pipe can be moved, in a lateral position, robotically or manually to a top drive. The top drive can then lift an individual piece into the wellbore. The top drive also can also rotate the pipe to spin it into a female threaded “box end” of the existing drill string in the wellbore. A roughneck can be used such as to help torque the connection to make sure it is tight and doesn't come loose downhole. Drilling a well generally involves assembling relatively long lengths of drill pipe connected end-to-end as a “drill string”. The length of a fully assembled drill string can range from about 30 feet to several miles. A bottom hole assembly including a drill bit can be placed at the tip of the drill string. Fluid can be pumped down an inner passage of the pipe and the fluid can drive a drill bit. For example, fluid can be pumped down a central passage of the pipe and can return up the wellbore within an outside annular passage surrounding the drill string. FIG. 1 depicts an example of a drill rig 100 including a rig derrick 102. In an approach to assembly and operation of a drill rig, one or more pieces of drill pipe can be suspended from a mast 106 of the derrick and raised toward a height of about 50-70 feet above the surface of the ground. For example, pipe stands can be picked up by the top drive one by one either from delivery at the catwalk or from the setback area. The individual pieces of drill pipe can be sequentially “threaded” into the drill string. In order to do this, a “stand” of drill pipe, e.g., an assembled section of drill pipe between about 60-90 feet long, is suspended vertically from the top drive, above the well bore. For example, a stand of drill pipe can include at least two pieces of drill pipe, and the process of drilling a well can generally involve the assembly of several stands of drill pipe.

A catwalk 108 can be located adjacent to the drill rig 100 at ground level. The catwalk 108 can include a pipe-receiving area and can function to help lift a length of drill pipe and deliver it to the drill floor in a generally horizontal or canted position. Drill pipe can be positioned horizontally in the pipe-receiving area of the catwalk 108 and can be fed into an inclined ramp or conveyor 110. An elevator can be attached to the drill pipe, e.g., loosely fitting around the body of the drill pipe such that the elevator abuts an upset in the pipe, or a collar threaded to an end of the pipe. The elevator can act as a “clamp” that is connected to the top drive by a one or more swinging bails. The elevator can grab the top of the drill pipe that is delivered by the conveyor on the catwalk and can lift it upwardly allowing the bottom end of the drill pipe or pipe stand to swing in underneath it. For example, the elevator can be used to grip drill pipe, such as via gripping fingers or hooks engaging the outer surface of the drill pipe. The top drive can be moveably (up/down) suspended from the mast. Here, the top drive and the elevator can grab and lift the pipe to move it from a horizontal to a vertical position. At some point, once the pipe is vertically arranged and hung below the top drive by the elevator, string in the wellbore. After drilling is completed, and as the drill string is pulled from the wellbore, drill pipes or pipe stands are removed from the top of the drill string and placed in a setback area or disassembled for removal from the rig.

Lengthening of the drill string can be performed multiple times during a drilling operation. For example, the first stand of drill pipe can be placed into the well during the initial drilling operation. Portions of the drill string 104 can be supplied to the catwalk 108 in smaller lengths to help ease in handling and transportation to and from the rig 100, such as via one or more containers 112 (also depicted in FIG. 2A). A challenge with particular approaches to supplying portions of the drill string 104 via a pipe rack is that individual stands of drill pipe must be lifted and placed onto the pipe-receiving area of the catwalk 108. This process can be time consuming, costly, and can pose health and safety risks to personnel performing certain manual lifting techniques. In another approach, a human-assisted mechanism can be provided to help in lifting drill pipe from the pipe rack onto the catwalk. For example, a crane or winch can be provided to lift the pipe from the container to the catwalk, or drill pipe can be rolled. These types of approaches can be costly, however, and can involve the use of several pieces of equipment and associated personnel that can further complicate the process of lengthening the drill string and potentially bend or otherwise damage the drill pipe. Further, handling drill pipe supplied by a plurality of pipe racks, e.g., arranged adjacent to one another, can present even greater challenges in lifting the pipe to the pipe-receiving area of the catwalk. The present inventors have recognized a need for a robotic drill pipe handling system 150 to help transfer individual pieces of drill pipe or drill pipe stands from a pipe rack to the pipe-receiving area of the catwalk. Such a robotic pipe handling system 150 can include at least two robotic manipulators, one positioned on either side of an individual piece of drill pipe, to pick the individual piece up and move it horizontally from one point to another. The present robotic system 150 can help reduce the need for certain mechanical systems, such as conveyor belts, chains, and other moving machine parts, that can present challenges such as being unreliable and causing pipes to bend or deflect. The present robotic system 150 can also reduce the need for certain manual handling techniques of drill pipe and promote the safety of individuals working near the drill rig.

FIG. 2A and FIG. 2B are perspective views of an example of a robotic handling system 150 arranged adjacent to a catwalk as a part of a drill rig 100. The robotic handling While this document generally refers to operations for supplying pipe for assembly to a drill rig, similar operations can be performed, e.g., in a reverse order such as to disassemble, store, or transport components of a drill string. As depicted in FIG. 2A and as described herein, the terms “drill pipe” and “segments of drill pipe” can also refer to a stand of drill pipe, e.g., as assembled sections of at least two pieces of drill pipe.

In an example, the robotic handling system can include at least one elongate drill pipe storage area or elongate container 112, a first robotic manipulator 114a, a second robotic manipulator 114b, and a system controller 120 communicatively coupled to the first and second manipulators 114a & 114b for coordinating movements to horizontally lift drill pipe 118 from the elongate container 112 and move the drill pipe 118 toward a pipe-receiving area. In one or more examples, such as where multiple containers 112 are provided, the system may also include a track or rail 116 allowing the manipulators 114a/114b to move relative to the containers. Herein, the “pipe-receiving area” can refer to a portion of the catwalk, another elongate container 112, or other destination for horizontal pipe-handling such as a wash station or an elevator. As depicted, multiple elongate containers 112 can be arranged adjacent to one another to increase the stock of drill pipe available to supply to the drill rig. While FIG. 2A shows that one or more elongate containers 112 can be arranged on one side of the catwalk 108, the drill rig 100 can similarly include a robotic handling system 150 including elongate containers 112 on both longitudinal sides of the catwalk 108. Still other container arrangements may also be provided.

FIG. 2B is a detailed view depicting an example of a robotic manipulator of FIG. 2A. An example of a robotic manipulator is described in U.S. patent application Ser. No. 17/250,548, entitled “END EFFECTORS FOR AUTOMATED PIPE HANDLING”, which is incorporated by reference herein in its entirety. An individual robotic manipulator 114, e.g., one of the first and second robotic manipulators 114a and 114b, can include a base portion 126, an articulated arm 122, and an end effector 124 arranged at an end of the articulated arm.

The robotic manipulator 114 can include a base portion 126 including skids or rollers configured for sliding engagement with a track or rail 116. The base portion 126 is configured for moving the robotic manipulator 114 along the track or rail 116 and to support the articulated arm 122. The base portion 126 can include a frame, box, or base including a mounting feature for receiving a corresponding articulated arm 122. The base portion 126 can the frame, box, or base. The base portion 126 can house one or more drives or motors for moving the robotic manipulator along the track or rail 116. As described further below, the one or more drives or motors can move the robotic manipulator along the track 116, which can be mounted atop one or more elongate containers 112 in a transverse direction orthogonal to the longitudinal direction of the elongate container 112. In an example, the base portion 126 can include skids or rollers for engaging one or more guide blocks of a corresponding track 116. Alternatively, the skids or rollers of the base portion 126 can include protrusions or the guide block can be recessed or shaped to receive the skids or rollers of the robot. By nature of the track 116 being arranged across a plurality of elongate containers 112, as depicted in FIG. 2A, the bass portion 126 of the robotic manipulator 114 can move along the track to travel between different elongate containers 112.

In an example, the articulated arm 122 can include one or more joints including or operated by an actuator configured to move or rotate that joint, e.g., relative to another joint or relative to the base portion 126. The actuator can include, e.g., a motor, a hydraulic cylinder, a pneumatic cylinder, a pair of pneumatic pistons, or a gripper for gripping drill pipe. For example, the articulated arm 122 can include a plurality of joints and corresponding actuators configured to move or rotate the articulated arm relative to the base portion 126. The articulated arm 122 can include one or more rotary joints and/or one or more linear actuators configured to move and rotate the articulated arm. The combined effect of the actuators and joints can move the articulated arm 122 in a desired direction and/or to a desired position relative to the base portion 126. In an example, the number of joints and actuators of the articulated arm 122 can vary, e.g., depending on a desired application. The joints can include, e.g., a shoulder joint, an elbow joint, a wrist joint, or a gripper joint. Where a plurality of joints are included, the corresponding actuators can be attached to the joints such that each joint can be moved independent from movement of the other joints. Here, the joints can be configured to move the articulated arm 122 in any of the x, y and z directions, e.g., relative to the base portion 126.

The end effector 124 can include a gripper or other mechanism configured to engage a corresponding drill pipe 110 of the pipe string 108. The end effector 124 can be arranged at an end of the articulated arm 122 and can be configured to engage and lift drill pipes 110 from the elongate container 112, move drill pipes 110 from one container to another, and/or place pneumatic cylinder, a hydraulic cylinder, a pair of pneumatic pistons, or a pair of hydraulic pistons. In an example, the end effector 124 can include a pair of pipe-engaging jaws. Each jaw can have an inner contour configured to receive and engage with a section, length, or stand of pipe. The end effector 124 can be configured to rotate or pivot between an open configuration and a closed configuration with respect to a pipe section. In an open configuration, the end effector 124 can be configured to receive the pipe section between the two jaws, with a longitudinal axis of the pipe section arranged parallel to the two planes on which the inner contours are arranged. With the pipe section arranged between the two jaws, the end effector 124 can be configured to rotate or pivot to a closed configuration where the two inner contours can each engage, or otherwise partially surround, the pipe section. In an example, one or both jaws can be actuatable. For example, one or both jaws can be actuatable at a hinged connection or pivot-type connection. Other gripping, holding, or suctioning mechanisms can be included in the end effector 124, e.g., clamping mechanisms, latching mechanisms, suctioning mechanisms, suction grippers, or vacuum grippers. In an example, the end effector 124 can define an inner contour or gap, such as between jaws thereof, for receiving the individual segment of drill pipe. The inner contour or gap can have a size and shape configured to engage with one or more pipe diameters, e.g., such that each jaw can be configured to extend around at least a portion of an outer wall of a pipe. In an example, the inner contour can have a semi-circular, semi-oval, or otherwise rounded, curved, or concave shape. The contour can be defined with a diameter of between approximately 1 inch and approximately 12 inches, or between approximately 2 inches and approximately 10 inches, or between approximately 4 inches and approximately 6 inches.

The robotic manipulator can also include or be communicatively coupled to a manipulator controller 140 (as shown in FIG. 3C) communicatively coupled with the base portion 126, the articulating arm 122, the end effector, 124, and at least one sensor or at least one actuator. In an example, the manipulator controller 140 can include or use a main computer and a plurality of sensors including one or more of an accelerometer, an ultrasound, a proximity, or a load sensor. The manipulator controller 140 can include or use at least one camera, optical or touch based sensor, a robot vision sensor, or an image processing algorithm. In an example, the manipulator controller 140 can also include a plurality of drives actuators (e.g., from the base portion 126, or including one or more motors, hydraulics, pneumatic valves, or the like. area included as a part of a robotic pipe handling system 150. The robotic pipe handling system 150 can include at least one elongate drill pipe storage area or elongate container 112, a first robotic manipulator 114a, a second robotic manipulator 114b, and a system controller 120 communicatively coupled to the first and second manipulators 114a & 114b for coordinating movements to horizontally lift an individual piece drill pipe 130 (e.g., as depicted in FIG. 3B) from the elongate container 112 and move the individual piece of drill pipe 130 toward a pipe-receiving area.

The elongate drill pipe storage area 112 can be included in the robotic handling system to supply drill pipe to the drilling rig, e.g., from an offsite location. The elongate drill pipe storage area 112 can house individual pieces of drill pipe or drill pipe stands and provide the drill pipe for being lifted by the first and second manipulators 114a & 114b. The elongate drill pipe storage area can also facilitate removal therefrom by releasing or uncovering individual pieces of drill pipe for being lifted by the first and second manipulators 114a & 114b.

The elongate drill pipe storage area 112 can be mounted to a trailer frame for transporting the elongate drill pipe storage area 112 and its contents, e.g., drill pipe, to and from a drilling rig location. The trailer frame can include side beams, a front portion, and a rear portion. The trailer frame can facilitate moving the elongate drill pipe storage area 112, e.g., by a vehicle or other movable platform. The trailer frame can include wheels, tracks, or other mode of movement to facilitate the transport of the elongate drill pipe storage area 112. The elongate drill pipe storage area 112 can include a connection mechanism to facilitate coupling to a trailer frame and/or a drilling rig. The connection mechanism can include a hitch, a pin and/or a locking mechanism to couple the elongate drill pipe storage area 112 to the trailer frame and/or drilling rig. The connection mechanism can further include a clamping mechanism to secure the elongate drill pipe storage area 112 to the trailer frame and/or drilling rig. The connection mechanism can further include an interface to facilitate coupling of the elongate drill pipe storage area 112 to a trailer frame and/or drilling rig. The interface can include a plug, a socket, or other coupling mechanism. The trailer frame can further include brakes and/or other locking or stopping mechanisms to facilitate the transport and use of the elongate drill pipe storage area 112. mechanisms, e.g., tie-downs, clamps, and/or other securing mechanisms, to secure the elongate drill pipe storage area 112 to the trailer frame. The securing mechanisms can help to prevent the elongate drill pipe storage area 112 from moving while in transport. The securing mechanisms can also help to prevent the elongate drill pipe storage area 112 from becoming damaged due to movement, e.g., shifting, jarring, and/or other movement.

The elongate drill pipe storage area 112 can be sized and shaped as an elongate container 112 or alternatively can be an unenclosed rack or pipe-suspender. The container 112 can include sidewalls, end walls, and a bottom. For example, the container 112 can be included as a part of a trailer that can be towed by a vehicle, such as a truck, to and from a drill rig. Also, for example, the container 112 can be a stand-alone container that can be transported by road or by boat, such as a barge, to and from a drill rig. Generally, the container 112 can a plurality of drill pipe receptacles 128, e.g., supported by the end walls, the side walls, or vertical spacers 122 attached to the end walls or the side walls.

By way of example only, the container 112 can have a length of at least 20 ft (6 m), such as a length between 30 ft (9.1 m) to about 100 ft (30.4 m), a width of about 12 ft (3.6 m), and a depth of between 3 ft (0.9 m) to about 5 ft (1.5 m). The container 112 can be sized such that it has sufficient internal space to hold, for example, at least three drill pipe lengths 130 (e.g., as depicted in FIG. 3B) with clearance between each drill pipe length 130 and any other drill pipe length in the container 112. The elongate container 112 can include a plurality of receptacles 128 (as depicted in the cross-section of FIG. 3C) each sized and shaped to hold an individual segment of drill pipe 130 oriented in a longitudinal direction across the container 112. Each of the receptacles 128 can be provided with a retaining element for securing the segment of drill pipe 130 therein. The retaining element can be a pin, ring, tab, collar, threading, protrusion, groove, projection, etc. that is engageable with the slot. In an example, a receptacle 128 can include or define an opening or aperture in the side wall or end wall of the container 112.

As depicted in FIG. 3C, individual segments of drill pipe 130 can be arranged in rows and the rows can be stacked upon one another. For example, the first container 108 can include one or more retractable vertical spacers 122. An individual retractable vertical spacer 122 can include an arm portion, an articulation joint (e.g., a horizontal or vertical pivot), and a drive. An individual retractable vertical spacer 122 can be arranged such as to support a first For example, each row of individual segments of drill pipe 130 can be supported be first and second vertical spacers 122 arranged toward each respective end of the individual segments of drill pipe 130. The individual retractable vertical spacer 122 can be retractable via the drive radially (e.g., by turning the spacer 122 on a point at or near an end of the spacer 112) or laterally, e.g., by a the drive (e.g., an electric motor or a hydraulic motor) that moves the articulation joint of the retractable vertical spacer 122 relative to the drill pipe segments 130. In an example, the system controller 120 can be included such as to trigger retracting of the retractable vertical spacer 122 via the drive upon receiving an indication that each individual piece of drill pipe from the topmost row has been removed or can be void from removal from respective corresponding drill pipe receptacles.

Returning to FIG. 3A, the elongate drill pipe storage area 112 can include a plurality of leveling jacks 134 that can function to vertically adjust a height of the elongate drill pipe storage area 112 with respect to a catwalk, another elongate drill pipe storage area 112, or other components of a drilling rig. The leveling jacks 134 can be attached to a bottom, a side wall or an end wall of the elongate drill pipe storage area 112. The leveling jacks 134 can also promote be arranged at multiple points along the elongate drill pipe storage area 112 to help promote the stability of the elongate drill pipe storage area 112, e.g., to help compensate for uneven ground there beneath. In an example, the leveling jacks 134 can include, for example, gas-filled cylinders that are filled with compressed air, nitrogen, or other suitable pressurization gas. The leveling jacks 134 can also be hydraulically activated. For example, the leveling jacks 134 can include an air or hydraulic cylinder, hydraulic cylinder, or other suitable mechanism to vertically adjust the elongate drill pipe storage area 112. The leveling jacks 134 can also be fluidly coupled to a fluid operated motor, such as a pneumatic or hydraulic motor. The leveling jacks 134 can be connected to a controller to cause the leveling jacks 134 to actuate. For example, when a motor of a leveling jack 134 is activated, the leveling jack 134 can extend or retract a piston to cause a corresponding change in height of the elongate drill pipe storage area 112. Accordingly, the leveling jacks 134 can be arranged such as to extend or retract to change the height of the elongate drill pipe storage area 112. In an example, the elongate drill pipe storage area 112 can include or be attached to a manifold, or other suitable apparatus that can deliver pressurized fluid to the cylinders that are included in the leveling jacks 134. Thus, the leveling jacks 134 can raise or lower the elongate drill pipe storage area 112, as well as adjust the length of the elongate drill pipe storage area 112, during operation of the drill rig, e.g., ensure the elongate drill pipe storage area 112 remains level during operations.

The elongate drill pipe storage area 112 can be coupled to the first and second linear tracks 116 for facilitating movement of the first and second robotic manipulators 114a and 114b, respectively, across a width of the drill pipe storage area 112 or across multiple drill pipe storage areas. The first and second linear tracks 116 can include one or more rails, e.g., arranged in a parallel or perpendicular orientation with respect to each other. The rails can be formed of a rigid material such as steel, aluminum, or the like. Also, the first and second linear tracks 116 can include one or more bearings, rollers, wheels, or other components that promote ease of movement of the first and second robotic manipulators 114a and 114b along the tracks 116. The first and second linear tracks 116 can be mounted to the drill pipe storage area 112 by any suitable mounting mechanism, such as, for example, brackets, clamps, bolts, screws, or the like. Alternatively or additionally to the base portion 126 including a drive to move an individual robotic manipulator 114 across the first and second linear tracks 116, the tracks 116 can also include one or more drive mechanisms for mechanically moving the first and second robotic manipulators 114a and 114b, respectively, along the rails. The drive mechanisms can include, for example, a motor, a gearbox, or a belt system.

FIG. 4 is a block diagram illustrating components of a machine 400, according to some example embodiments, able to read instructions 424 from a machine-storage medium 422 (e.g., a non-transitory machine-storage medium, a machine-storage medium, a computer-storage medium, or any suitable combination thereof) and perform any one or more of the methodologies discussed herein, in whole or in part. Specifically, FIG. 4 shows the machine 400 included in the system controller 120 (as depicted in FIG. 2A) in the example form of a computer system (e.g., a computer) within which the instructions 424 (e.g., software, a program, an application, an applet, an app, or other executable code) for causing the machine 400 to perform any one or more of the methodologies discussed herein can be executed, in whole or in part. For example, the instructions 424 can be processor executable instructions that, when executed by a processor (e.g., a processor included the system controller 120 of FIG. 2A) of the machine 400, cause the machine 400 to perform the operations outlined above.

In various embodiments, the machine 400 operates as a standalone device or can be communicatively coupled (e.g., networked) to other machines. In a networked deployment, the machine 400 can operate in the capacity of a server machine or a client machine in a server-environment. The machine 400 can be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 424, sequentially or otherwise, that specify actions to be taken by that machine. Further, while only a single machine is illustrated, the term “machine” shall also be taken to include any collection of machines that individually or jointly execute the instructions 424 to perform all or part of any one or more of the methodologies discussed herein.

The machine 400 can include a processor 402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 404, and a static memory 406, which are included such as to communicate with each other via a bus 408. In an example, the processor 402 can be included with or communicatively coupled to the system controller 120 as described in FIG. 2A. The processor 402 can contain microcircuits that are configurable, temporarily or permanently, by some or all of the instructions 424 such that the processor 402 is configurable to perform any one or more of the methodologies described herein, in whole or in part. For example, a set of one or more microcircuits of the processor 402 can be configurable to execute one or more modules (e.g., software modules) described herein.

The machine 400 can further include a graphics display 410 (e.g., a plasma display panel (PDP), a light emitting diode (LED) display, a liquid crystal display (LCD), a projector, a cathode ray tube (CRT), or any other display capable of displaying graphics or video). The machine 400 can also include an alphanumeric input device 412 (e.g., a keyboard or keypad), a cursor control device 414 (e.g., a mouse, a touchpad, a trackball, a joystick, a motion sensor, an eye tracking device, or other pointing instrument), a storage unit 416, an audio generation device 418 (e.g., a sound card, an amplifier, a speaker, a headphone jack, any suitable combination thereof, or any other suitable signal generation device), and a network interface device 420.

The storage unit 416 can include the machine-storage medium 422 (e.g., a tangible and non-transitory machine-storage medium) on which are stored the instructions 424, embodying any one or more of the methodologies or functions described herein. The instructions 424 can also reside, completely or at least partially, within the main memory 404, within the processor 402 (e.g., within the processor's cache memory), or both, before or during execution thereof considered machine-storage media (e.g., tangible and non-transitory machine-storage media). The instructions 424 can be transmitted or received over the network 426 via the network interface device 420. For example, the network interface device 420 can communicate the instructions 424 using any one or more transfer protocols (e.g., Hypertext Transfer Protocol (HTTP)).

In some example embodiments, the machine 400 can be a portable computing device, such as a smart phone or tablet computer, and have one or more additional input components (e.g., sensors 428 or gauges). Examples of the additional input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components can be accessible and available for use by any of the modules described herein.

### Executable Instructions and Machine-Storage

The various memories (i.e., 404, 406, and/or memory of the processor(s) 402) and/or storage unit 416 can store one or more sets of instructions and data structures (e.g., software) 424 embodying or utilized by any one or more of the methodologies or functions described herein. These instructions, when executed by processor(s) 402 cause various operations to implement the disclosed embodiments.

As used herein, the terms “machine-storage medium,” “device-storage medium,” “computer-storage medium” (referred to collectively as “machine-storage medium 422”) mean the same thing and can be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 422 include non-volatile memory, including by way of example semiconductor memory devices, e.g., erasable programmable read-only memory (EPROM), electrically erasable disks such as internal hard disks and removable disks; magneto-optical disks; and CD-ROM and DVD-ROM disks. The terms machine-storage medium or media, computer-storage medium or media, and device-storage medium or media 422 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Coputer Readable Medium

The terms “machine-readable medium,” “computer-readable medium” and “device-readable medium” mean the same thing and can be used interchangeably in this disclosure. The terms are defined to include both machine-storage media and signal media. Thus, the terms include both storage devices/media and carrier waves/modulated data signals.

Returning to FIG. 2A, in operation and use, the first robotic manipulator 114a can be positioned at, near, and/or above a first end of an individual elongate container 112, and the second robotic manipulator 114b can be positioned at, near, and/or above a second, opposite end of the individual elongate container 112. The first robotic manipulator 114a can hold, grip, grab, or otherwise contact an individual segment of drill pipe at or near a first end, and the second robotic manipulator 114b can similarly contact the individual segment of drill pipe at or near a second end. Here, a weight of the individual segment of drill pipe can be distributed, such as substantially evenly distributed, between the first and second robotic manipulators 114a and 114b during a horizontal lift of the individual segment of drill pipe from the corresponding first drill pipe receptacle. Herein, “substantially evenly distributed” can refer to a distribution wherein any difference between respective loads on the first robotic manipulator 114a and the second robotic manipulator 114 b is less than 5% of a weight of the individual segment of drill pipe. Also, the weight of the individual segment of drill pipe can be distributed between the first and second robotic manipulators at a ratio within a range of 1:1 and 1:2. Here, a ratio of second robotic manipulator 114b equally bear the weight of the individual segment of drill pipe, and a ratio of one to two can refer to a configuration wherein the first robotic manipulator 114a bears one third of the weight of the individual segment of drill pipe, and the second robotic manipulator 114b bears two thirds of the weight of the individual segment of drill pipe. A similar distribution can be provided vice versa.

In an example, the first and second robotic manipulators 114a and 114b can communicate via with the system controller or with each other via a network connection or a wireless communication, such as via a suitable communication frequency or wave, to effectuate horizontal lift and movement. For example, the wireless communication can be provided by a transceiver, transmitter, or transponder located on a robotic manipulator, or by a suitable device that is operably coupled to the first and second robotic manipulators 114a and 114b. As such, the first and second robotic manipulators 114a and 114b can effectuate horizontal lift and movement of the individual segment of drill pipe by wireless communication, and other robotic handling system can likewise effectuate horizontal lift and movement of the individual segment of drill pipe. The first and second robotic manipulators can also be communicatively coupled to each other or the system controller 120 via a wired connection.

The controller 120 can be communicatively coupled to at least the first and second robotic manipulators 114a and 114b and also to upstream componentry, e.g., via a control bus to provide movement control of the first robotic manipulator 114a and second robotic manipulator 114b. A control algorithm can be programmed into the system controller 120 to provide the movement control of the first robotic manipulator 114a and the second robotic manipulator 114b. For example, the system controller 120 can control operation of the robotic handling system 150 by communicating, e.g., via the control bus to at least the first robotic manipulator 114a, the second robotic manipulator 114b, and optionally the corresponding an individual drill pipe receptacles or a sensor onboard a manipulator 114 or an elongate container 112. Here, the system controller 120 can receive data to help determine where a target piece of drill pipe is located in the elongate container 112, and by determining if and when a segment of drill pipe is available from a corresponding first drill pipe receptacle. Such movement can be initiated and controlled as needed to supply the drill pipe 118 for lengthening of the drill string, such as including feedback from the upstream componentry. For example, the system controller 120 can determine of more drill pipe is needed at the catwalk 108 from the upstream robotic manipulator 114b.

In an example, the system controller 120 can receive feedback from the receptacles 128 such as to help coordinate movements of the first and second robotic manipulators 114a and 114b, e.g., to coordinate selection of a target individual piece of drill pipe 130. For example, the system controller 120 can select a target piece of drill pipe based on a specified order or priority of receptacles 128. Such a priority, with reference to, can include removing individual segments of drill pipe 130 from left to right (or vice versa) and by row from top to bottom. In particular, this priority can be based on the order of receptacles 128 that indicate a presence of an individual piece of drill pipe 130 should be removed from, e.g., the right-most receptacle, then the next-right-most receptacle, and so on. Individual drill pipe segments can be re-stacked into the elongate drill pipe storage area 112 in a similar fashion, e.g., in reverse.

FIG. 5 is a flowchart that describes a method for operating a robotic system.

In an example, at 510, the method can include arranging at least one elongate drill pipe storage area adjacent to the catwalk, the at least one elongate drill pipe storage area including a plurality of drill pipe receptacles.

At 520, the method can include holding a first portion of a first piece of drill pipe via a first robotic manipulator arranged toward a first end of the at least one elongate drill pipe storage area, the first portion extending toward a first end of the first piece of drill pipe.

In an example, at 530, the method can include holding a second portion of the first piece of drill pipe via a second robotic manipulator arranged toward a second end of the at least one elongate drill pipe storage area, the second portion extending toward a second end of the first piece of drill pipe opposite the first end.

At 540, the method can include horizontally lifting the first piece of drill pipe from a corresponding first drill pipe receptacle. For example, the horizontally lifting can include evenly distributing the load on the robotic system can be substantially between the first and second robotic manipulators. In an example, the horizontally lifting can include distributing the load on the robotic system at a ratio within a range of 1:1 and 1:2 between the first and second robotic manipulators. In an example, arranging at least one elongate drill pipe storage with the catwalk via adjusting plurality of leveling jacks.

At 550, the method can include carrying the first piece of drill pipe toward a pipe-receiving area, including controlling coordinated movements of the first and second robotic manipulators with each other. For example, the method can include guiding, via a linear track coupled to the at least one elongate drill pipe storage area, the first and second robotic manipulators in a transverse direction substantially orthogonal to a longitudinal direction of the at least one elongate drill pipe storage area. Also, carrying the first piece of drill pipe toward a pipe-receiving area can involve rolling, pushing, or sliding the drill pipe toward the pipe receiving area, e.g., along a track or a set of racks supporting the drill pipe. For example, carrying the first piece of drill pipe toward a pipe-receiving area can involve a combination of vertically lifting the drill pipe and horizontally rolling the drill pipe via the first and second robotic manipulators.

In an example, the method can also include receiving, via a sensor, an indication of contact with an individual piece of drill pipe and e.g., restricting motion of at least one of the first or second robotic manipulators until receiving an indication of contact with the individual piece of drill pipe from the other robotic manipulator. This can help ensure the distribution of the load across the first and second robotic manipulators and can help prevent the dropping of an individual piece of drill pipe or damage to the robotic pipe handling system.

In an example, the method can include retracting a vertical spacer upon receiving an indication that each individual piece of drill pipe from a first stack of drill pipe has been removed or can be void from removal from respective corresponding drill pipe receptacles. Here, when in a non-retracted position, the vertical spacer can support a first stack of individual drill pipe pieces above a second stack of individual drill pipe pieces.

FIG. 6A, FIG. 6B, and FIG. 6C depict an assembly and operation of an example of a robotic pipe handling system as a part of a drill rig. The robotic pipe handling system 150 can include a plurality of elongate drill pipe storage areas or elongate containers 112, a first robotic manipulator 114a, a second robotic manipulator 114b to horizontally lift drill pipe from the elongate container 112 and move the drill pipe 130 toward a pipe-receiving area 136.

As depicted in FIG. 6A, a first elongate drill pipe storage area can be arranged alongside a catwalk 108 of a drill rig such that it is adjacent to a drill pipe receiving area 136. 136, or the catwalk 108 can define a drill pipe receiving area itself. In an example where the first elongate drill pipe storage area 112 is included in or coupled to a trailer for being towed by a vehicle, the first elongate drill pipe storage area 112 can be towed next to the drill pipe receiving area 136 and can be brought approximately level with the catwalk 108, the drill pipe receiving area 136, or both via a plurality of jacks mounted on upon the first elongate drill pipe storage area 112.

As depicted in FIG. 6B, second and third elongate drill pipe storage areas 112 can be placed adjacent to one another, lengthwise, such as to form a line of elongate drill pipe storage areas 112. Here, each subsequently placed elongate drill pipe storage area 112 can be further offset from the catwalk 108. To help the first and second robotic manipulators 114a and 114b traverse the resulting offset, first and second linear tracks 116 can be placed across the widths of each drill pipe storage area. In an example, the first and second linear tracks 116 can be placed on or along respective mounts of the drill pipe storage areas 112 to ensure accurate and repeatable arrangement of the track with respect to drill pipe receptacles of each of the elongate drill pipe storage areas. This can help reduce recalibration procedures necessary to orient the first and second robotic manipulators upon setup and teardown of the robotic pipe handling system. Once the first and second linear tracks 116 have been the respective mounts of the drill pipe storage areas 112, the first and second robotic manipulators 114a and 114b can be respectively placed along or attached to the first and second linear tracks 116.

As depicted in FIG. 6C, the first and second robotic manipulators 114a and 114b can be controlled such as to move drill pipe from one of the first, second, or third elongate drill pipe storage areas 112 toward the drill pipe receiving area 136. In an example, a supplementary drill pipe storage area 138 can be placed adjacent to the elongate drill pipe storage area 112 that is furthest offset form the catwalk 108. Here the supplementary drill pipe storage area 138 can be a rack or a container that is able to be manually reloaded with drill pipe, such as via a forklift, crane, or human personnel. In an example, the first and second linear tracks 116 can not span a width of the supplementary drill pipe storage area 138, but the first and second robotic manipulators 114a and 114b can approach the supplementary drill pipe storage area 138 toward respective edges of the tracks 116 to lift and move supplementary drill pipe from the supplementary drill pipe storage area. In a similar fashion, other components of the drill storage area, such as drill collar, heavy drill bits, drill bit adapters, kelly, and the like.

The following, non-limiting examples, detail certain aspects of the present subject matter to solve the challenges and provide the benefits discussed herein, among others.

Example 1 is a robotic system for delivering drill pipe to a drill rig, comprising: a drill pipe container configured for holding a plurality of horizontally oriented drill pipes; a first and a second robotic manipulator each arranged toward respective ends of the drill pipe container and each configured to selectively grab, hold, and move drill pipe; a system controller in signal communication with the first and second robotic manipulators and configured to control the first and second robotic manipulators in coordinated fashion to: grab respective portions of a selected drill pipe of the plurality of horizontally oriented drill pipes; lift the selected drill pipe clear of the container; and deliver the selected drill pipe to a pipe receiving area.

In Example 2, the subject matter of Example 1 includes, wherein the drill pipe container includes a first container including a plurality of receptacles each sized and shaped to hold an individual piece of drill pipe oriented in a longitudinal direction across the first container.

In Example 3, the subject matter of Example 2 includes, wherein the drill pipe container includes first and second mounts respectively located at the first and second ends of the drill pipe container, the first and second mounts sized and shaped to respectively receive the first and second robotic manipulators.

In Example 4, the subject matter of Example 3 includes, wherein the first and second mounts each include linear track arranged to respectively guide the first and second robotic manipulators in a transverse direction substantially orthogonal to the longitudinal direction.

In Example 5, the subject matter of Example 4 includes, wherein the drill pipe container includes a second container arranged to hold individual pieces of drill pipe in a longitudinal direction across the second container, wherein the linear track of the first and second mounts permit travel of the first and second robotic manipulators across the first container and the second container.

In Example 6, the subject matter of Example 5 includes, wherein the system controller is configured to coordinate movements of the first and second robotic manipulators spaced apart from the first drill pipe receptacle.

Example 7 is a robotic system for feeding drill pipe for assembly at or near a catwalk of a drill rig, the system comprising: at least one elongate drill pipe storage area including a plurality of drill pipe receptacles; a first robotic manipulator, arranged toward a first end of the at least one elongate drill pipe storage area, the first robotic manipulator configured to hold a first portion of a first piece of drill pipe, the first portion extending toward a first end of the first piece of drill pipe; a second robotic manipulator, arranged toward a second end of the at least one elongate drill pipe storage area, the second robotic manipulator configured to hold a second portion of the first piece of drill pipe, the second portion extending toward a second end of the first piece of drill pipe opposite the first end; and a system controller configured to coordinate movements of the first and second robotic manipulators with each other to horizontally lift the first piece of drill pipe from a corresponding first drill pipe receptacle and move the first piece of drill pipe toward a pipe-receiving area; 7 is missing parent: 8. The robotic system of Example 7, wherein a load on the robotic system, including a weight of the first piece of drill pipe, is distributed between the first and second robotic manipulators during a horizontal lift of the first piece of drill pipe from the corresponding first drill pipe receptacle.

In Example 8, the subject matter of Example 7 includes, wherein the load on the robotic system is substantially evenly distributed between the first and second robotic manipulators.

In Example 8, the subject matter of Examples 7-8 includes, wherein the load on the robotic system is distributed between the first and second robotic manipulators at a ratio within a range of one to one and one to two.

In Example 9, the subject matter of Examples 7-9 includes, wherein the at least one elongate drill pipe storage area includes a first container including a plurality of receptacles each sized and shaped to hold an individual piece of drill pipe oriented in a longitudinal direction across the first container.

In Example 10, the subject matter of Example 10 includes, wherein the at least one elongate drill pipe storage area includes first and second mounts respectively located at the first and second ends of the at least one drill pipe storage area, the first and second mounts sized and shaped to respectively receive the first and second robotic manipulators.

In Example 11, the subject matter of Example 11 includes, wherein the first and second mounts each include linear track arranged to respectively guide the first and second direction.

In Example 12, the subject matter of Example 12 includes, wherein the at least one elongate drill pipe storage area includes a second container arranged to hold individual pieces of drill pipe in a longitudinal direction across the second container, wherein the linear track of the first and second mounts permit travel of the first and second robotic manipulators across the first container and the second container.

In Example 13, the subject matter of Example 13 includes, wherein the system controller is configured to coordinate movements of the first and second robotic manipulators with each other to a second piece of drill pipe from a corresponding second drill pipe receptacle spaced apart from the first drill pipe receptacle.

In Example 14, the subject matter of Examples 10-14 includes, wherein the first container includes a plurality of leveling jacks.

In Example 15, the subject matter of Examples 10-15 includes, wherein the first container includes a retractable vertical spacer configured to support a first row of individual drill pipe pieces above a second row of individual drill pipe pieces.

In Example 16, the subject matter of Example 16 includes, wherein the system controller is configured to trigger retracting of the retractable vertical spacer upon receiving an indication that each individual piece of drill pipe from the first row has been removed or is void from removal from respective corresponding drill pipe receptacles.

In Example 17, the subject matter of Examples 7-17 includes, wherein at least one of the first and second robotic manipulators is communicatively coupled to a sensor configured to receive an indication of contact with an individual piece of drill pipe.

In Example 18, the subject matter of Example 18 includes, wherein the sensor includes at least one of an optical sensor, a proximity sensor, or a force sensor.

In Example 19, the subject matter of Examples 7-19 includes, wherein the system controller is configured to target an individual receptacle of a container without receiving optical feedback related to the movement of the first robotic manipulator or the second robotic manipulator.

In Example 20, the subject matter of Examples 7-20 includes, wherein the system controller is configured to restrict motion of at least one of the first or second robotic manipulators until receiving an indication of contact from the other robotic manipulator.

Example 22 is a method for operating a robotic system to feed drill pipe for assembly at or near a catwalk of a drill rig, the method comprising: arranging at least one storage area including a plurality of drill pipe receptacles; holding a first portion of a first piece of drill pipe via a first robotic manipulator arranged toward a first end of the at least one elongate drill pipe storage area, the first portion extending toward a first end of the first piece of drill pipe; holding a second portion of the first piece of drill pipe via a second robotic manipulator arranged toward a second end of the at least one elongate drill pipe storage area, the second portion extending toward a second end of the first piece of drill pipe opposite the first end; horizontally lifting the first piece of drill pipe from a corresponding first drill pipe receptacle; and carrying the first piece of drill pipe toward a pipe-receiving area, including controlling coordinated movements of the first and second robotic manipulators with each other; wherein a load on the robotic system, including a weight of the first piece of drill pipe, is distributed between the first and second robotic manipulators during the horizontally lifting of the first piece of drill pipe from the corresponding first drill pipe receptacle.

In Example 22, the subject matter of Example 22 includes, wherein the horizontally lifting includes evenly distributing the load on the robotic system is substantially between the first and second robotic manipulators.

In Example 23, the subject matter of Examples 22 -22 includes, wherein the horizontally lifting includes distributing the load on the robotic system at a ratio within a range of one to one and one to two between the first and second robotic manipulators.

In Example 24, the subject matter of Examples 22-24 includes, guiding, via a linear track coupled to the at least one elongate drill pipe storage area, the first and second robotic manipulators in a transverse direction substantially orthogonal to a longitudinal direction of the at least one elongate drill pipe storage area.

In Example 25, the subject matter of Example 25 includes, guiding, via a linear track coupled to a first elongate drill pipe storage area and a second elongate drill pipe storage area, the first and second robotic manipulators between the first elongate drill pipe storage area and the second elongate drill pipe storage area.

In Example 26, the subject matter of Example 26 includes, horizontally lifting a second piece of drill pipe from a corresponding second drill pipe receptacle spaced apart from the first drill pipe receptacle; and carrying the first piece of drill pipe toward a pipe-receiving area, including controlling coordinated movements of the first and second robotic manipulators with each other. at least one elongate drill pipe storage area adjacent to the catwalk includes leveling the at least one elongate drill pipe storage area with the catwalk via adjusting plurality of leveling jacks.

In Example 28, the subject matter of Examples 22-28 includes, retracting a vertical spacer upon receiving an indication that each individual piece of drill pipe from a first row of drill pipe has been removed or is void from removal from respective corresponding drill pipe receptacles, the vertical spacer configured to support a first row of individual drill pipe pieces above a second row of individual drill pipe pieces.

In Example 29, the subject matter of Examples 22-29 includes, receiving, via a sensor, an indication of contact with an individual piece of drill pipe.

In Example 30, the subject matter of Examples 22-30 includes, restricting motion of at least one of the first or second robotic manipulators until receiving an indication of contact from the other robotic manipulator.

Example 32 is at least one machine-readable medium including instructions that, when executed by processing circuitry, cause the processing circuitry to perform operations to implement of any of Examples 1-31.

Example 33 is an apparatus comprising means to implement of any of Examples 1-31.

Example 34 is a system to implement of any of Examples 1-31.

Example 35 is a method to implement of any of Examples 1-31.

The above Detailed Description can include references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A robotic system for delivering drill pipe to a drill rig, comprising:
a drill pipe container configured for holding a plurality of horizontally oriented drill pipes;
a first and a second robotic manipulator each arranged toward respective ends of the drill pipe container and each configured to selectively grab, hold, and move drill pipe;
a first and second linear track arranged to guide the first and second robotic manipulators in a transverse direction substantially orthogonal to a longitudinal direction of the drill pipe container, the first and second robotic manipulators configured to move independently along the first and second linear track; and
a system controller in signal communication with the first and second robotic manipulators and configured to control the first and second robotic manipulators in coordinated fashion to:
grab respective portions of a selected drill pipe of the plurality of horizontally oriented drill pipes;
lift the selected drill pipe clear of the container; and
deliver the selected drill pipe to a pipe receiving area.

2. The robotic system of claim 1, wherein the drill pipe container includes a first container including a plurality of receptacles each sized and shaped to hold an individual piece of drill pipe oriented in a longitudinal direction across the first container.

3. The robotic system of claim 2, wherein the drill pipe container includes first and second mounts respectively located at the first and second ends of the drill pipe container, the first and second mounts sized and shaped to respectively receive the first and second robotic manipulators.

4. (canceled)

5. The robotic system of claim 1, wherein the drill pipe container includes a second container arranged to hold individual pieces of drill pipe in a longitudinal direction across the second container, wherein the first and second linear track permit travel of the first and second robotic manipulators across the first container and the second container.

6. The robotic system of claim 5, wherein the system controller is configured to coordinate movements of the first and second robotic manipulators with each other to a second piece of drill pipe from a corresponding second drill pipe receptacle spaced apart from the first drill pipe receptacle.

7. A robotic system for feeding drill pipe for assembly at or near a catwalk of a drill rig, the system comprising:
at least one elongate drill pipe storage area including a plurality of drill pipe receptacles;
a first robotic manipulator, arranged toward a first end of the at least one elongate drill pipe storage area, the first robotic manipulator configured to hold a first portion of a first piece of drill pipe, the first portion extending toward a first end of the first piece of drill pipe;
a second robotic manipulator, arranged toward a second end of the at least one elongate drill pipe storage area, the second robotic manipulator configured to hold a second portion of the first piece of drill pipe, the second portion extending toward a second end of the first piece of drill pipe opposite the first end;
a first and second linear track arranged to guide the first and second robotic manipulators in a transverse direction substantially orthogonal to a longitudinal direction of the at least one elongate drill pipe storage area, the first and second robotic manipulators configured to move independently along the first and second linear track; and
a system controller configured to coordinate movements of the first and second robotic manipulators with each other to horizontally lift the first piece of drill pipe from a corresponding first drill pipe receptacle and move the first piece of drill pipe toward a pipe-receiving area.

8. The robotic system of claim 7, wherein a load on the robotic system, including a weight of the first piece of drill pipe, is distributed between the first and second robotic manipulators during a horizontal lift of the first piece of drill pipe from the corresponding first drill pipe receptacle.

9. The robotic system of claim 7, wherein the load on the robotic system is substantially evenly distributed between the first and second robotic manipulators.

10. The robotic system of claim 7, wherein the load on the robotic system is distributed between the first and second robotic manipulators at a ratio within a range of one to one and one to two.

11. The robotic system of any of claim 7, wherein the at least one elongate drill pipe storage area includes a first container including a plurality of receptacles each sized and shaped to hold an individual piece of drill pipe oriented in a longitudinal direction across the first container.

12. The robotic system of claim 11, wherein the at least one elongate drill pipe storage area includes first and second mounts respectively located at the first and second ends of the at least one drill pipe storage area, the first and second mounts sized and shaped to respectively receive the first and second robotic manipulators.

13. (canceled)

14. The robotic system of claim 7, wherein the at least one elongate drill pipe storage area includes a second container arranged to hold individual pieces of drill pipe in a longitudinal direction across the second container, wherein the first and second linear track permit travel of the first and second robotic manipulators across the first container and the second container.

15. The robotic system of claim 14, wherein the system controller is configured to coordinate movements of the first and second robotic manipulators with each other to a second piece of drill pipe from a corresponding second drill pipe receptacle spaced apart from the first drill pipe receptacle.

16. (canceled)

17. The robotic system of claim 11, wherein the first container includes a retractable vertical spacer configured to support a first row of individual drill pipe pieces above a second row of individual drill pipe pieces.

18. The robotic system of claim 17, wherein the system controller is configured to trigger retracting of the retractable vertical spacer upon receiving an indication that each individual piece of drill pipe from the first row has been removed or is void from removal from respective corresponding drill pipe receptacles.

19.-20. (canceled)

21. The robotic system of claim 7, wherein the system controller is configured to target an individual receptacle of a container without receiving optical feedback related to the movement of the first robotic manipulator or the second robotic manipulator.

22. (canceled)

23. A method for operating a robotic system to feed drill pipe for assembly at or near a catwalk of a drill rig, the method comprising:
arranging at least one elongate drill pipe storage area adjacent to the catwalk, the at least one elongate drill pipe storage area including a plurality of drill pipe receptacles;
guiding, via a first and second linear track coupled to the at least one elongate drill pipe storage area, the first and second robotic manipulators in a transverse direction substantially orthogonal to a longitudinal direction of the at least one elongate drill pipe storage area, the first and second robotic manipulators configured to move independently along the first and second linear track;
holding a first portion of a first piece of drill pipe via a first robotic manipulator arranged toward a first end of the at least one elongate drill pipe storage area, the first portion extending toward a first end of the first piece of drill pipe;
holding a second portion of the first piece of drill pipe via a second robotic manipulator arranged toward a second end of the at least one elongate drill pipe storage area, the second portion extending toward a second end of the first piece of drill pipe opposite the first end;
horizontally lifting the first piece of drill pipe from a corresponding first drill pipe receptacle; and
carrying the first piece of drill pipe toward a pipe-receiving area, including controlling coordinated movements of the first and second robotic manipulators with each other;
wherein a load on the robotic system, including a weight of the first piece of drill pipe, is distributed between the first and second robotic manipulators during the horizontally lifting of the first piece of drill pipe from the corresponding first drill pipe receptacle.

24.-26. (canceled)

27. The method of claim 23, comprising guiding, via the first and second linear track coupled to a first elongate drill pipe storage area and a second elongate drill pipe storage area, the first and second robotic manipulators between the first elongate drill pipe storage area and the second elongate drill pipe storage area.

28. The method of claim 27, comprising:
horizontally lifting a second piece of drill pipe from a corresponding second drill pipe receptacle spaced apart from the first drill pipe receptacle; and
carrying the first piece of drill pipe toward a pipe-receiving area, including controlling coordinated movements of the first and second robotic manipulators with each other.

29. (canceled)

30. The robotic system of claim 23, comprising retracting a vertical spacer upon receiving an indication that each individual piece of drill pipe from a first row of drill pipe has been removed or is void from removal from respective corresponding drill pipe receptacles, the vertical spacer configured to support a first row of individual drill pipe pieces above a second row of individual drill pipe pieces.

31.-33. (canceled)
